(19) United States
(12) Patent Application Publication
(10) Pub. No.: US 2018/0206661 A1
(43) Pub. Date: Jul. 26, 2018

(54) MAILBOX WITH WIRELESS COMMUNICATION FUNCTION

(71) Applicant: Primax Electronics Ltd., Taipei (TW)

(72) Inventors: SHI-JIE ZHANG, Taipei (TW); CHE-YEN HUANG, Taipei (TW); YING-CHE TSENG, Taipei (TW); WEN-PIN HSIEH, Taipei (TW)

(21) Appl. No.: 15/651,967

(22) Filed: Jul. 17, 2017

(30) Foreign Application Priority Data
Jan. 25, 2017 (TW) 106102951

(51) Int. Cl. A47G 29/12; H04B 7/26; G07C 9/00; A47G 29/124

(52) U.S. Cl. CPC A47G 29/1214; H04B 7/26; G07C 9/00896; H04W 4/008; G07C 9/00309; A47G 29/124; G07C 9/00007

(57) ABSTRACT

The present invention provides a mailbox with a wireless communication function, used to perform a wireless connection with an electronic apparatus, and including: a mailbox, having a delivery slot and a letter-getting door; and a control module, used to control a wireless module and a locking module, where the control module detects the electronic apparatus by using the wireless module to perform the wireless connection, and the locking module is disposed on the letter-getting door and is used to lock the letter-getting door, where when the control module determines that a received signal strength indicator of the wireless connection is greater than a signal strength default value, the control module releases locking of the locking module to open the letter-getting door.

### FIELD OF THE INVENTION

The present invention relates to the application field of integration of technologies of the Internet of Things, and in particular, to a system for opening a mailbox with a wireless communication function by using an electronic apparatus.

### BACKGROUND OF THE INVENTION

With the progress of science and technology, application of the smart home and the Internet of Things makes life of modern people more convenient. People can control various different electric appliances in home life by using an electronic apparatus, such as a mobile phone, a computer, or a tablet computer, in combination with integration of technologies of the Internet of Things. A computer, a television, a lamp, a refrigerator, an air conditioner, a robot cleaner, a house letter-getting door, and even a mailbox may be switched on or off or may be opened or closed by means of a wireless connection technology of the Internet of Things.

In the prior art, with regard to a mailbox with a wireless function, for example, Taiwan Patent Publication No. TWM489595 provides a smart mailbox having an optoelectronic switch and a double-sided scanner. Whether a letter is delivered into the mailbox can be detected by means of the optoelectronic switch, appearances of front and back sides of the letter are scanned by using the double-sided scanner, and subsequently, scanned images are transmitted to a mobile phone to enable a user of the smart mailbox to learn a letter status in the mailbox in real time. Alternatively, for example, Japan Patent Publication No. JP 2016-101450A provides a mailbox body having a mail delivery confirmation apparatus. The mailbox body can send letter images and related information to a mobile electronic apparatus to prompt a user. Moreover, the user may also operate the mobile electronic apparatus and unlock the mailbox body by means of Bluetooth wireless communication to get a letter in the mailbox.

However, in the prior art, a user usually needs to unlock a smart mailbox by means of cumbersome operation steps, and consequently, inconvenience of using the smart mailbox by the user may be caused, and on the other hand, the public is less willing to use the smart mailbox.

Therefore, how to simplify steps of taking a letter out of a smart mailbox to enable a user to conveniently take out the letter is a technical issue to be resolved by the present invention.

### SUMMARY OF THE INVENTION

A main objective of the present invention lies in providing a mailbox with a wireless communication function, and controlling opening or closing of the mailbox by means of a state or strength of a wireless connection between the mailbox with a wireless communication function and an electronic apparatus, so as to simplify steps of opening the mailbox, and enable a user to take out a letter in the mailbox more conveniently. On the other hand, letter delivery information and letter image information of the letter may be transmitted to an electronic apparatus or a network cloud space of the user by means of the wireless connection, so that the user knows the letter delivery information and can check appearance images of the letters in advance.

To achieve the foregoing objective, the present invention provides a mailbox with a wireless communication function, used to perform wireless connection with an electronic apparatus, and including: a mailbox, having a delivery slot and a letter-getting door; and a control module, used to control a wireless module and a locking module, where the control module detects the electronic apparatus by using the wireless module to perform the wireless connection, and the locking module is disposed on the letter-getting door and is used to lock the letter-getting door, where when the control module determines that a received signal strength indicator of the wireless connection is greater than a signal strength default value, the control module releases locking of the locking module to open the letter-getting door.

In the foregoing preferred implementation manner, the electronic apparatus is: a notebook computer, a tablet computer, a personal digital assistant, a smartphone, a game console, a smartwatch, or a smart bracelet.

In the foregoing preferred implementation manner, the control module is a microcontroller unit.

In the foregoing preferred implementation manner, the wireless module is: a radio frequency wireless transmission module, a Bluetooth wireless transmission module, a ZigBee wireless transmission module, or a WiFi wireless transmission module.

In the foregoing preferred implementation manner, the locking module includes: a locking portion and a locking member.

In the foregoing preferred implementation manner, the mailbox with a wireless communication function further includes a sensing module, where the sensing module is disposed in the delivery slot and is used to detect a letter that enters through the delivery slot and generate letter delivery information, where the letter delivery information is transmitted to the electronic apparatus by means of the wireless connection.

In the foregoing preferred implementation manner, the mailbox with a wireless communication function further includes a scanning module, where when the sensing module detects that the letter enters into the delivery slot, the scanning module is started to scan the letter and generate letter image information, and the letter image information is transmitted to the electronic apparatus by means of the wireless connection.

### BRIEF DESCRIPTION OF THE DRAWINGS

FIG. 1 is a mailbox with a wireless communication function according to the present invention;

FIG. 2A and FIG. 2B are schematic diagrams of an installation implementation according to the present invention; and

FIG. 3A and FIG. 3B are schematic diagrams of use scenarios of a mailbox with a wireless communication function according to the present invention.

### DETAILED DESCRIPTION OF THE PREFERRED EMBODIMENT

Advantages and features of the present invention and a method for implementing same will be described in a more detailed way with reference to exemplary embodiments and the accompanying drawings for easier understanding. However, the present invention may be implemented in different forms and should not be understood to be limited only to the embodiments stated herein. On the contrary, for persons of ordinary skill in the art, the provided embodiments will make the present disclosure more thorough and more comprehensive and completely convey the scope of the present invention.

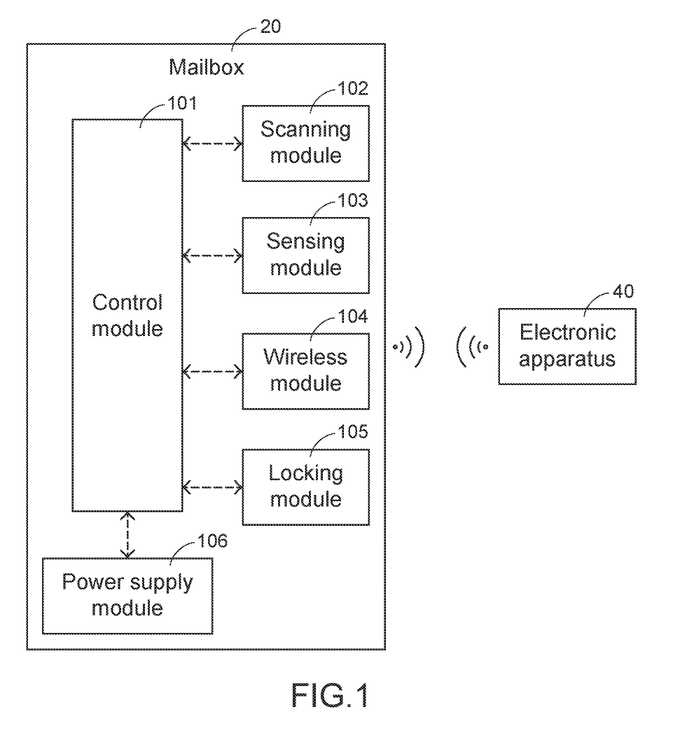

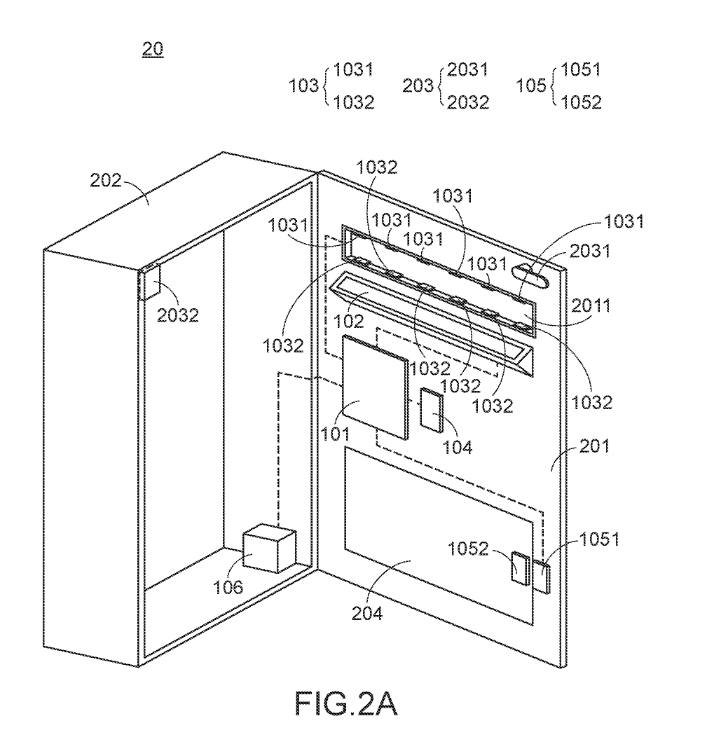

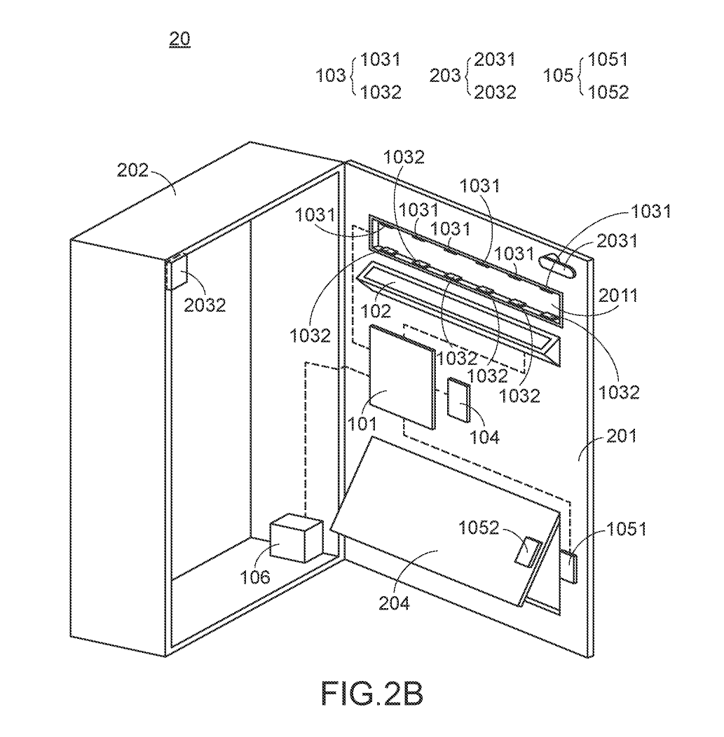

First, referring to FIG. 1 and FIG. 2A, FIG. 1 is a mailbox with a wireless communication function according to the present invention, and FIG. 2A is a schematic diagram of an installation implementation according to the present invention. In FIG. 1, the mailbox with a wireless communication function includes: a mailbox 20, which is provided with: a control module 101, a scanning module 102, a sensing module 103, a wireless module 104, a locking module 105, and a power supply module 106. The control module 101 is a microcontroller unit (MCU), which is electrically connected to the scanning module 102, the sensing module 103, the wireless module 104, the locking module 105, and the power supply module 106. The power supply module 106 is used to supply power for the control module 101, the scanning module 102, the sensing module 103, the wireless module 104, and the locking module 105 during operation. The power supply module 106 may be a home power supply or a portable charging apparatus. In addition, the power supply module 106 may be disposed inside or outside the mailbox 20 according to the structural design of the mailbox 20. When the control module 101 detects and confirms, by means of the wireless module 104, that an electronic apparatus 40 exists in an environment, the control module 101 establishes a wireless connection with the electronic apparatus 40 by means of the wireless module 104 and performs pairing to confirm a user identity of the electronic apparatus 40, and at the same time, information and data may be transmitted by means of the wireless connection. The control module 101 includes a memory unit (not shown in the figure). The memory unit is used to store at least one piece of user identity information of the electronic apparatus 40 for pairing by the control module 101. On the other hand, the control module 101 also synchronously detects a received signal strength indicator (RSSI) of the wireless connection, and determines whether a value of the received signal strength indicator is greater than a signal strength default value. After the mailbox 20 establishes the wireless connection with the apparatus electronic 40 and confirms the user identity, if the control module 101 detects that the received signal strength indicator is greater than the signal strength default value, the control module 101 releases a locking state of the locking module 105. The electronic apparatus 40 of the present invention may be: a notebook computer, a tablet computer, a personal digital assistant, a smartphone, a game console, a smartwatch, or a smart bracelet. The wireless module 104 may be: a radio frequency (RF) wireless transmission module, a Bluetooth wireless transmission module, a ZigBee wireless transmission module, or a WiFi wireless transmission module, and the signal strength default value may be adjusted according to a type of the used wireless module 104.

Subsequently, referring to FIG. 2A, the mailbox 20 includes: a mailbox body 202 having an accommodating space and a box door 201. The box door 201 includes: a delivery slot 2011 for entry of a letter, a letter-getting door 204 that can be opened/closed, and a box door lock 203. The box door lock 203 includes: a rotating member 2031 disposed on the box door 201 and a stopping portion 2032 disposed on the mailbox body 202. When the box door 201 is closed and seals the mailbox body 202, the rotating member 2031 may rotate to a position of the stopping portion 2032 to maintain the box door 201 in a closed and sealed state. The locking module 105 is disposed on the letter-getting door 204 and is used to lock the letter-getting door 204. The locking module 105 includes: a locking portion 1051 disposed on the box door 201 and a locking member 1052 disposed on the letter-getting door 204. The locking module 105 of the present invention is an electromagnetic lock. The locking portion 1051 is powered on to generate a magnetic force to attract the locking member 1052 on the letter-getting door 204. In this case, the letter-getting door 204 is in a locked state and cannot be opened. Although only an implementation manner of the electromagnetic lock is provided for the locking module 105 of the present invention, electromechanical locks of other different types can also be used in actual application. The present invention is not limited to the electromagnetic lock.

Continuing to refer to FIG. 2A, the sensing module 103 is disposed in the delivery slot 2011, and includes: a plurality of light emitting elements 1031 and a plurality of light receiving elements 1032. The light receiving elements 1032 can receive light rays emitted from the light emitting elements 1031. The scanning module 102 is disposed at a lower edge position of the delivery slot 2011. When a letter enters through the delivery slot 2011, because the letter blocks the light rays emitted from the light emitting elements 1031, resistance values of the light receiving elements 1032 change due to a failure to receive the light rays. In this case, the control module 101 determines that a letter enters into the delivery slot 2011, immediately starts the scanning module 102 disposed on the lower edge of the delivery slot 2011, and uses the scanning module 102 to scan the letter that enters into the delivery slot 2011. After scanning is completed, letter delivery information and letter image information are generated. The letter delivery information includes a time or a date of letter delivery, and the letter image information includes an appearance image of a front side or a back side of the letter. After the control module 101 establishes the wireless connection with the electronic apparatus 40 by means of the wireless module 104 and confirms a user identity, the letter delivery information and the letter image information may be transmitted to the electronic apparatus 40 by means of the wireless connection. A user can learn information, such as the time or date of letter delivery, or the appearance image of the front side or the back side of the letter, by means of the electronic apparatus 40. Certainly, the control module 101 may also upload the letter delivery information and the letter image information to a network cloud space by means of the wireless module 104. The user can learn information, such as the letter delivery information: the time or date of letter delivery, or the appearance image of the front side or the back side of the letter, by means of an Internet of Things system. In the scanning module 102, a type of a photosensitive element (not shown in the figure) thereof may be a charge coupled device (CCD), a contact image sensor (CIS), or a complementary metal-oxide-semiconductor (CMOS). In addition, although the present invention provides only an implementation manner of disposing the scanning module 102 at the lower edge position of the delivery slot 2011, in actual application, the scanning module 102 may be disposed at different positions of the mailbox 20 according to different types of the photosensitive element or different structures of the mailbox 20. The present invention is not limited to the implementation manner of disposing the scanning module 102 at the lower edge position of the delivery slot 2011.

Referring to FIG. 1 and FIG. 2B, FIG. 2B is a schematic diagram of an installation implementation according to the present invention. After the control module 101 detects the electronic apparatus 40 by means of the wireless module 104, establishes the wireless connection with the electronic apparatus 40, and performs pairing to confirm the user identity, if a letter has been delivered into the mailbox 20 at the time, the letter delivery information and the letter image information are transmitted to the electronic apparatus 40 by means of the wireless connection. In addition, the control module 101 further detects the received signal strength indicator of the wireless connection, and determines whether the value of the received signal strength indicator is greater than the signal strength default value. The signal strength default value ranges between −68 dbm and −73 dbm (in this case, a distance between the electronic apparatus 40 and the mailbox 20 is equal to approximately 3 to 5 meters). When the received signal strength indicator of the wireless connection is greater than the signal strength default value, the control module 101 releases the locking state of the locking module 105. In this case, because the locking portion 1051 has been powered off, the locking portion 1051 has no magnetic force to attract the locking member 1052. Therefore, the letter-getting door 204 is in an unlocked/open state. The user can open the letter-getting door 204 to take the letter out of the mailbox 20. Although the present invention provides only an implementation manner of opening the letter-getting door 204 inward, in actual application, an opening manner thereof may be adjusted according to structural design of the mailbox itself. For example, the letter-getting door 204 is opened outward, opened to the right, opened to the left, or opened in a sliding manner. The present invention is not limited to the manner of being opened inward. In addition, for example, to simplify design, the letter-getting door 204 may be omitted. Instead, the locking module 105 is disposed at a position of the box door lock 203. When the control module 101 releases the locking state of the locking module 105, the user may directly open the box door 201 to take a letter out of the mailbox 20.

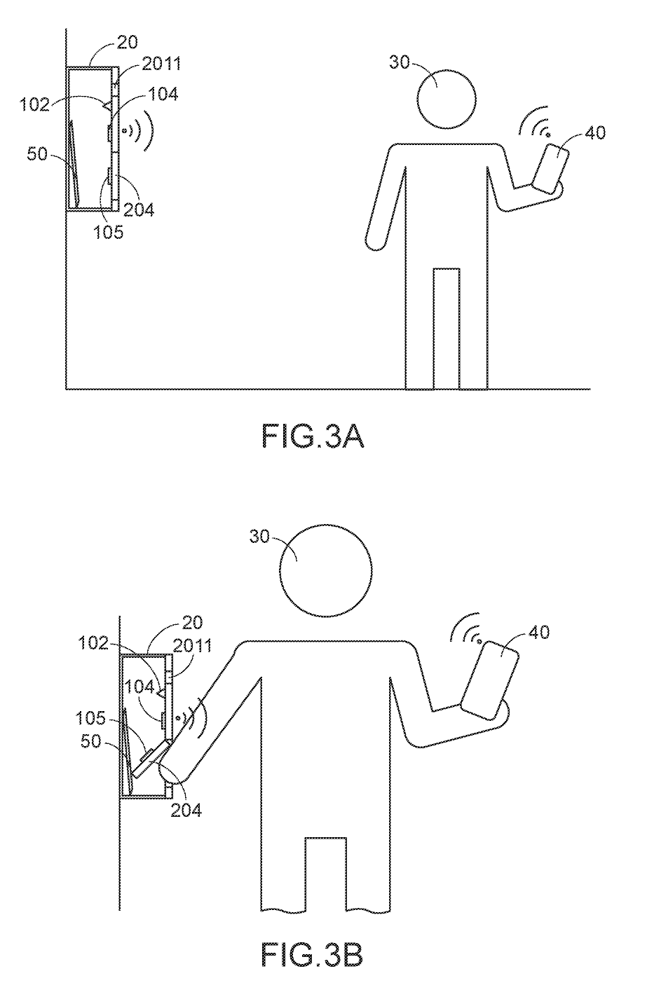

Continuing to refer to FIG. 3A and FIG. 3B, FIGS. 3A and 3B are schematic diagrams of use scenarios of the mailbox with a wireless communication function according to the present invention. In FIG. 3A, there is a letter 50 in the mailbox 20. When a user 30 holds the electronic apparatus 40 in hand and approaches to the mailbox 20, the wireless module 104 detects the electronic apparatus 40 and transmits, by means of the wireless connection, the letter delivery information and the letter image information that is generated by the scanning module 102 after scanning the letter 50 to the electronic apparatus 40. The user 30 may learn that the letter 50 is in the mailbox 20 and an appearance image of the letter 50 by means of the electronic apparatus 40. Subsequently, continuing to refer to FIG. 3B, when the user 30 approaches to the mailbox 30 to make the value of the received signal strength indicator greater than the signal strength default value (for example, the user 30 stands in front of the mailbox 20 at a distance of a step), the mailbox 20 releases the locking state of the locking module 105, and the user 30 can open the letter-getting door 204 to take out the letter 50. However, when the user 30 is distant from the mailbox 20, resulting in that the value of the received signal strength indicator is less than the signal strength default value, or the electronic apparatus 40 is outside a scope that can be detected by the wireless module 104, the mailbox 20 immediately locks the letter-getting door 204 by using the locking module 105, so that the letter-getting door 204 is switched into a state in which the letter-getting door 204 is sealed and cannot be opened.

As compared with the prior art, according to the present invention, opening/closing of a letter-getting door or a box door is controlled by means of a magnitude of a received signal strength indicator of a wireless connection between an electronic apparatus and a mailbox with a wireless communication function, so as to simplify steps of opening/closing the mailbox, and enable a user to take out a letter in the mailbox more conveniently. In addition, according to the mailbox with a wireless communication function, letter delivery information and letter image information of the letter may be transmitted to the electronic apparatus or a network cloud space by means of the wireless connection in advance, so that the user can learn the letter delivery information by means of the electronic apparatus or an Internet of Things system, and may check an appearance image of the letter, and so that user can immediately learn a sender of the letter or a subject of the letter. Therefore, the present invention is actually a creation with great industrial value.

Various modifications made by persons skilled in the art to the present invention all fall within the protection scope of the appended claims.

What is claimed is:

1. A mailbox with a wireless communication function, used to perform wireless connection with an electronic apparatus, comprising:
a mailbox, having a delivery slot and a letter-getting door; and
a control module, used to control a wireless module and a locking module, wherein the control module detects the electronic apparatus by using the wireless module to perform the wireless connection, and the locking module is disposed on the letter-getting door and is used to lock the letter-getting door, wherein
when determining that a received signal strength indicator of the wireless connection is greater than a signal strength default value, the control module releases locking of the locking module to open the letter-getting door.

2. The mailbox with a wireless communication function according to claim 1, wherein the electronic apparatus is: a notebook computer, a tablet computer, a personal digital assistant, a smartphone, a game console, a smartwatch, or a smart bracelet.

3. The mailbox with a wireless communication function according to claim 1, wherein the control module is a microcontroller unit.

4. The mailbox with a wireless communication function according to claim 1, wherein the wireless module is: a radio frequency wireless transmission module, a Bluetooth wireless transmission module, a ZigBee wireless transmission module, or a WiFi wireless transmission module.

5. The mailbox with a wireless communication function according to claim 1, wherein the locking module comprises: a locking portion and a locking member.

6. The mailbox with a wireless communication function according to claim 1, further comprising a sensing module, wherein the sensing module is disposed in the delivery slot and is used to detect a letter that enters through the delivery slot and generate letter delivery information, wherein the letter delivery information is transmitted to the electronic apparatus by means of the wireless connection.

7. The mailbox with a wireless communication function according to claim 6, further comprising a scanning module, wherein when the sensing module detects that the letter enters into the delivery slot, the scanning module is started to scan the letter and generate letter image information, wherein the letter image information is transmitted to the electronic apparatus by means of the wireless connection.
